(19) United States
(12) Patent Application Publication
(10) Pub. No.: US 2002/0029185 A1
(43) Pub. Date: Mar. 7, 2002

(54) Method and apparatus for providing broker service to auctions

(76) Inventors: Teruo Tanaka, Hadano (JP); Masaaki Higuchi, Hadano (JP); Masaru Yamada, Hadano (JP)

Correspondence Address: MATTINGLY, STANGER & MALUR, P.C., ATTORNEYS AT LAW, 104 EAST HUME AVENUE, ALEXANDRIA, VA, 22301, US

(21) Appl. No.: 09/873,259

(22) Filed: Jun. 5, 2001

(30) Foreign Application Priority Data
Sep. 5, 2000 (JP) 2000-273527

(51) Int. Cl. G06F 17/60

(52) U.S. Cl. 705/37

(57) ABSTRACT

A brokerage server for performing brokerage service is provided to assist a user to select auction sites on the Internet when the user puts up own commodity at a plurality of auction sites simultaneously. The brokerage server, which resides between an information terminal of the user and the auction servers, in response to a process request from the information terminal, refers to an auction site information file to locate the auction sites suitable for the user's requirement and send information about the suitable auction sites to an information terminal so that the user can select the auction sites where the commodity is to be put up. After registration of the commodity at the selected auction servers, the brokerage server monitors trading status at the sites where the commodity is auctioned and performs the brokerage service until termination of the auction.

### BACKGROUND OF THE INVENTION

The present invention relates to a method and an apparatus for auction brokerage service over the Internet, and more particularly to a method and an apparatus for auction brokerage service to locate auction sites that meet user's requirement on the Internet and provide the auction brokerage service so that the user can put up own commodity at a plurality of the auction sites simultaneously.

In recent years, as the Internet has become widespread explosively, new businesses on the Internet are operated prosperously. In such situation, one of the businesses that is operated on the Internet in an easy way is an auction, which conventionally has been operated in an certain circle in the real world for commodities such as paintings, antiques and the like. On the other hand, the emerging Internet auction business deals a wide variety of commodities including information apparatuses such as personal computers (PC) and their parts, automobile parts such as tires, retro-toys and so on. Various Internet auction services are implemented by many Internet providers, portal sites or on individual web sites. A user who wishes to participate in any auction on the Internet and put up own commodity at the auction independently locates auction sites to select and utilize the auction sites suitable for his/her purpose.

Users of the Internet auction services select the auction sites suitable for the commodity to be put up from many auction sites and register own commodity at the suitable auction sites. But, conditions to participate in each auction site may differ between auction sites. For example, you must pay a participation charge at some sites, or you must pay a commission after the conclusion of a trade. Further, auction periods may also differ between auction sites. Therefore, it is difficult to select suitable auction sites from a plurality of the auction sites. Generally speaking, in an auction, the more a commodity has found bidders, the more a possibility of conclusion at a higher price increases. Therefore, it is desirable to spread information in a wider range. But if a user participates in a plurality of auction sites and puts up same commodities there simultaneously, the user must check results at every auction site and deal with trades there separately.

### SUMMARY OF THE INVENTION

It is an object of the invention to provide a method and an apparatus for auction brokerage service that assists a user to select suitable auction sites and monitors trading status and/or termination of the auctions at each auction site on behalf of the user when the user puts up identical commodity at a plurality of the auction sites simultaneously.

This invention is characterized by a method for auction brokerage service provided by a computer that resides between an information terminal of a user and auction servers to perform brokerage operation for an auction, the method comprising the steps: communicating with the information terminal to locate the auction servers suitable for the user's requirement; communicating with the auction servers that have been selected by the user from the located auction servers to receive notification confirming that an auctioned commodity of the user has been registered at the auction servers; communicating with the auction servers to receive auction result information; and communicating with the information terminal to notify of the auction result information. This invention is also characterized by a computer providing the auction brokerage service comprising the above functions.

Also, this invention is characterized by the steps of monitoring trading status at a plurality of auction servers and communicating with relevant auction servers to notify the other auction sites of the highest tendered price among all tendered prices.

Further, this invention is characterized by a step of communicating with the relevant auction servers to alter the desired price according to the user's instruction when the commodity has found no buyer at every auction site where the commodity had been registered by the date specified by the user.

Still further, this invention is characterized by the step of communicating with the relevant auction servers to notify other auction sites of cancellation of registration of the corresponding commodity in case of termination of the auction when the commodity has found any buyer at any auction site.

### BRIEF DESCRIPTION OF THE DRAWINGS

FIG. 1 is a block diagram of an entire system of an embodiment of the invention;

FIG. 2 is a flow chart showing a registration process at an auction site according to an embodiment of the invention;

FIG. 3 is a drawing showing an example of an auctioning data input screen;

FIG. 4 is a drawing showing an example of an auction site selection screen;

FIG. 5 is a flow chart showing a process to acquire interim information at user's request according to an embodiment of the invention;

FIG. 6 is a flow chart showing a process to monitor trading status on a regular basis according to an embodiment of the invention; and

FIG. 7 is a flow chart showing an auction termination process according to an embodiment of the invention.

### DETAILED DESCRIPTION OF THE INVENTION

Referring to the drawings, an embodiment of the invention will be described as follows.

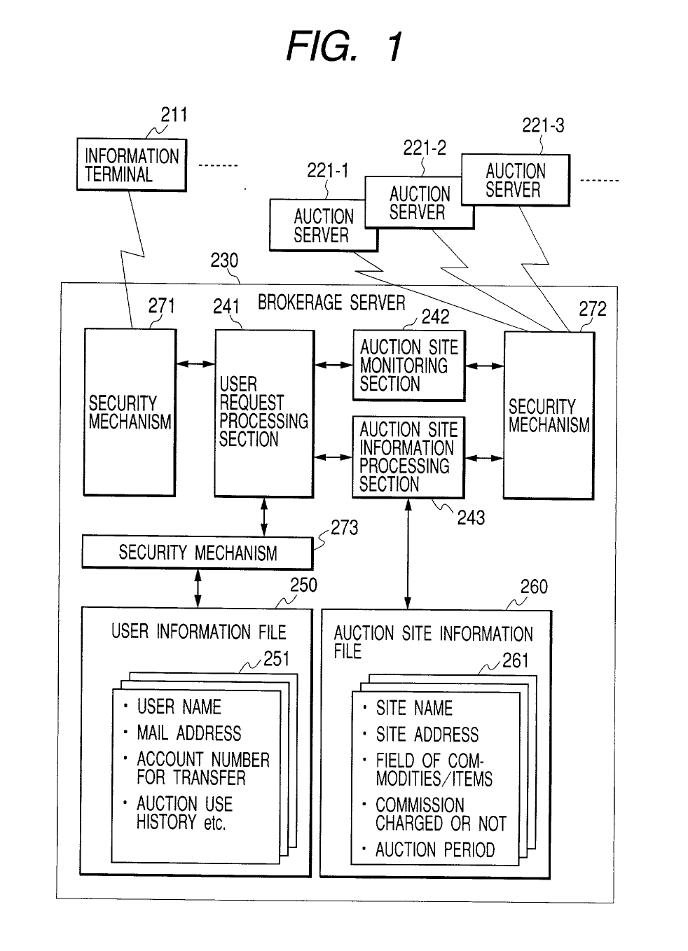

FIG. 1 is a diagram showing a system configuration including a brokerage server 230 for auction brokerage service. The system comprises a plurality of information terminals 211, auction servers 221 which are installed on each auction site, a brokerage server 230 which resides between the information terminals 211 and the auction servers 221, and the Internet which is a network interconnecting the apparatuses. The information terminal 211 is a computer-terminal apparatus such as a personal computer, a mobile terminal and the like, which requests to put up a commodity at an auction. The auction servers 221 are computers that, in response to a request for putting up of the commodity, register and disclose auction information about the commodity to the public and accept tenders from other information terminals (not shown). In the following, any of the plurality of auction servers 221-1, 221-2, 221-3 and so on is designated collectively as auction server(s) 221. The brokerage server 230 is a computer such as a purpose-built server computer, a personal computer and the like.

The brokerage server 230 stores a user information file 250 and an auction site information file 260 on its storage device. The user information file 250 holds both users authentication information and separate pieces of personal user information 251, each one of which stores personal information and auction use history for each user separately. The auction site information file 260 holds separate pieces of auction site information 261, each one of which includes a site name (a site identifier), a site address, a field of commodities/items, commission charged or not, an auction period and the like for each auction server 221 separately.

Main memory of the brokerage server 230 stores programs for each of a user request processing section 241, an auction site monitoring section 242 and an auction site information processing section 243, which are executed by the brokerage server 230. The user request processing section 241 performs a series of processes to accept an auctioning request from the information terminal 211, authenticate the user, register the user s commodity to be put up at auction sites selected by the user, and finally inform the information terminal 211 of the result. At the time of selection of the auction sites, the user request processing section 241 provides the user with information about the auction sites, referring to the personal user information 251 and the auction site information 261. Also, the user request processing section 241 accepts a request for an interim report on trading status from the information terminal 211 and then acquires interim information from the auction sites at which the auctioned commodity is registered to make the interim report to the information terminal 211. Further, at the time of termination of an auction, the user request processing section 241 reports an auction result to the information terminal 211.

The auction site information processing section 243, along with the process of the user request processing section 241, registers the user putting up own commodity at the auction servers 221 and acquires the interim report from the auction servers 221. The auction site information processing section 243 also receives notification about auction results from the auction servers 221 to convey such notification to the user request processing section 241. When an identical commodity is registered to be put up at a plurality of auction servers 221, the auction site monitoring section 242 acquires trading statuses of each auction site regularly, and unifies the maximum tendered prices for the commodity among all auction sites.

Security mechanisms 271 and 272 are hardware/software mechanisms installed to protect the brokerage server 230 from unauthorized access in the Internet. A security mechanism 273 is a program that protects the personal user information 251 in the user information file 250 and controls access to such information so that only the personal user information 251 corresponding to authorized users can be accessed.

The brokerage server 230 performs following processes:

(1) At the request of a user, it performs selection of auction sites and registration of the user putting up own commodity to auctions;

(2) At the request of the user, it acquires information about interim trading status of each auction site at which the user is registered (hereinafter referred to as “interim information”) and reports the information to the user;

(3) It monitors trading status of each auction site and unifies the maximum tendered price among all auction sites. It also performs an appropriate action when an auctioned commodity has not found a buyer;

(4) It receives notification of auction results from the auction sites and determines termination of the auction and, in case of termination, performs necessary process;

(5) It assists payment procedure after conclusion of a trade; and

(6) It accepts registration of information from auction sites.

In the following, details of each process will be described in sequence.

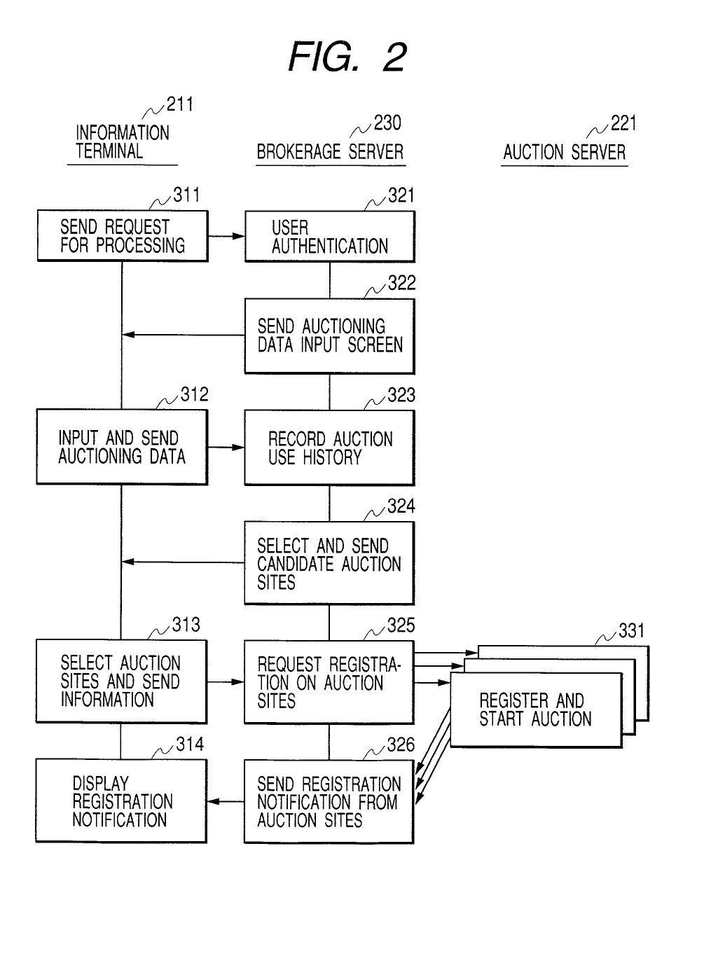

FIG. 2 is a flow chart showing a process flow of the process (1) performed by the user request processing section 241. The information terminal 211 sends a request for participation in an auction to the brokerage server 230 through the Internet (step 311). The user request processing section 241 of the brokerage server 230 receives authentication information such as a user ID, a password and the like from the information terminal 211 and performs user authentication with reference to the user information file 250 (step 321). Then, the user request processing section 241 sends an auctioning data input screen to the information terminal 211 (step 322), and the information terminal 211 displays the screen on its display device.

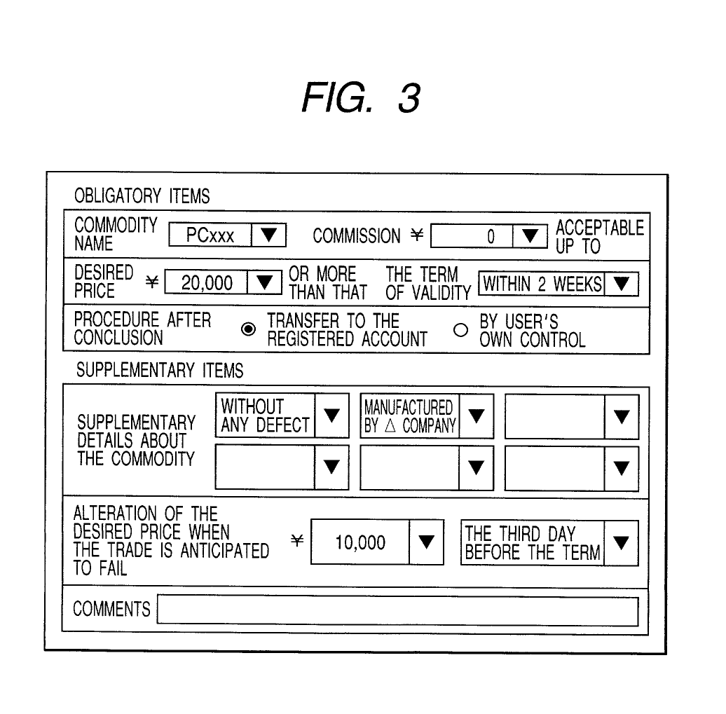

FIG. 3 is a drawing showing an example of the auctioning data input screen. On the screen there are provided input regions for both obligatory items and supplementary items about an auctioned commodity. In obligatory items, “commodity name” is a name of the auctioned commodity; “commission” is an upper limit of a payable commission; “desired price” is a lower limit of a desired selling price; and “the term of validity” is an entry to define an upper limit of the period before termination of the auction. “Procedure after conclusion” indicates a method of payment after conclusion of a trade, i.e. whether the payment will be transferred to the user's registered account or handled by user's own control. Each item is designed to be input through selection of pull-up menus and buttons to avoid uncertain entries. In supplementary items, then, “supplementary details about the commodity” is an entry to input features of the commodity such as: whether it is brand-new or second-hand, size of the commodity, whether accessories are included and so on. “Alternation of the desired price when the trade is anticipated to fail” is a data entry that can be set in case of alternation of the desired price when the trade has not been concluded by n (a specified number) day(s) before the termination of the auction. “Comments” is an entry to input an appeal of the commodity.

Returning to FIG. 2, the information terminal 211 inputs data in the auctioning data input screen and sends it to the brokerage server 230 (step 312). The user request processing section 241 receives the data and registers the received data as the use history in the personal user information 251 of the user information file 250 (step 323). Then, the user request processing section 241 retrieves each piece of the auction site information 261 in the auction site information file 260 via the auction site information processing section 243, locates an appropriate auction sites that satisfy the user's request, and sends information about the located auction sites to the information terminal 211 (step 324). The information terminal 211 displays the information on its display device in the form of the auction site selection screen. Here, auction sites that conform to the user's request in the items such as “field of commodities/items”, “commission” and “auction period” are selected.

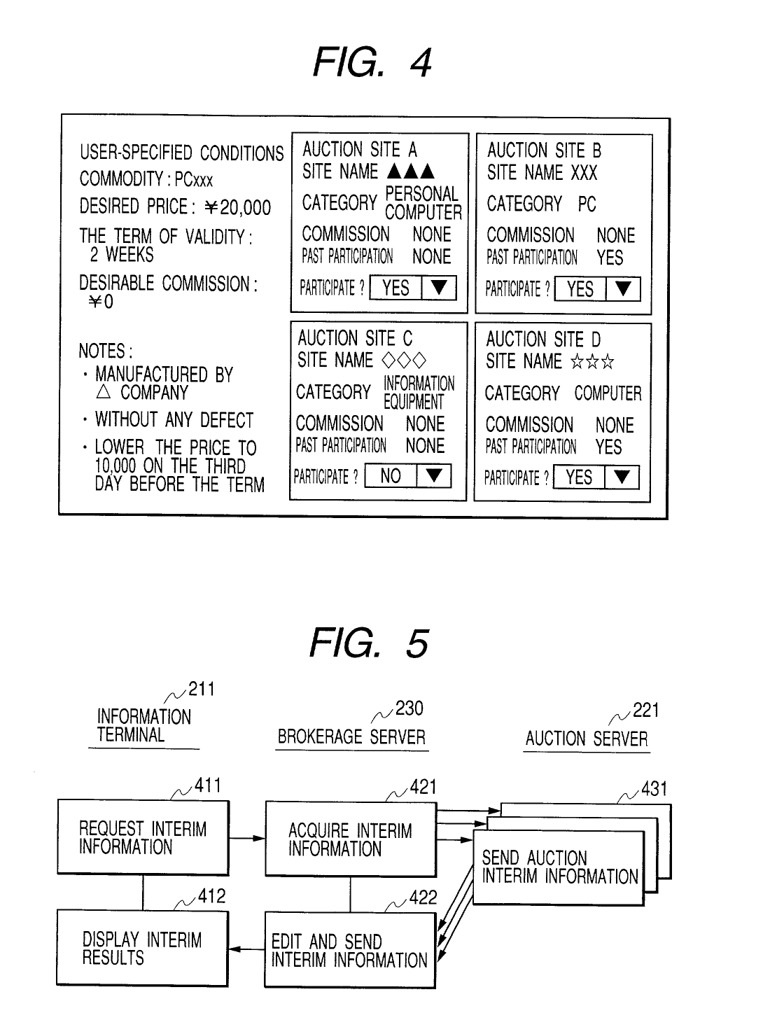

FIG. 4 is a drawing that shows an example of an auction site selection screen. In this example, it displays information about each candidate auction site as well as the conditions specified by the user for the user's reference. “Past participation” indicates whether the user has participated in any auction of the auction site before or not according to the user's use history recorded in the personal user information 251. “Participate? Yes/No” entry is a region to select whether the user will participate in the auction of the auction site or not. The user can select a plurality of the auction sites.

Returning to FIG. 2 again, once the user has selected appropriate auction sites, the information terminal 211 sends information including the auction site identifier and the like to the brokerage server 230 (step 313). The user request processing section 241 sends an auction registration request to the selected auction sites through the auction site information processing section 243 (step 325). Along with the request, it sends information such as the identifier of the brokerage server 230, a name of the user, a name of the commodity, a desired price, the term of validity, supplementary details about the commodity, comments and so on. Here, it is noted that it sends only necessary information according to conditions of the respective auction site. The auction servers 221 that have received the auction registration request assign a registration number and register the auctioned commodity to start its auction (step 331). The user request processing section 241 receives registration notification with the registration number from the auction sites at which the commodity has been registered, assigns an acceptance number and sends registration notification to the information terminal 211 (step 326). The registration notification is sent along with information including the acceptance number and the name of the auction sites that have sent the registration notification. The user request processing section 241 also records information such as the acceptance number, the name of each site that has sent the registration notification, each registration number and each auction period to corresponding piece of personal user information 251. On the other hand, the information terminal 211 receives the registration notification and displays it on its display device (step 314).

FIG. 5 is a flow chart showing a process flow of the user request processing section 241 and the auction site information processing section 243 to perform the process (2). The information terminal 211 sends a request to acquire trading status (the interim information) of the commodity registered for auctions along with its acceptance number to the brokerage server 230 (step 411). The user request processing section 241 receives the request, refers to corresponding piece of the personal user information 251 to get each site name and each registration number corresponding to the received acceptance number, sends the registration number to each auction server 221 at which the commodity is registered via the auction site information processing section 243 and requests information about the trading status in order to acquire the interim information (step 421). Each auction server 221 sends a web page in which the commodity of the specified registration number is registered to the brokerage server 230 (step 431). From the web page of each site received via the auction site information processing section 243, the user request processing section 241 acquires information to determine whether any buyer has been found, and if so, for which price the buyer has been found, edits such information and sends the interim information to the information terminal 211 (step 422). As the interim results, the user request processing section 241 sends information to indicate whether any buyer has been found for the commodity and, if found, the name of the site that sets the highest price for the commodity to the information terminal 211. The information terminal 211 displays the received interim results on its display device (step 412).

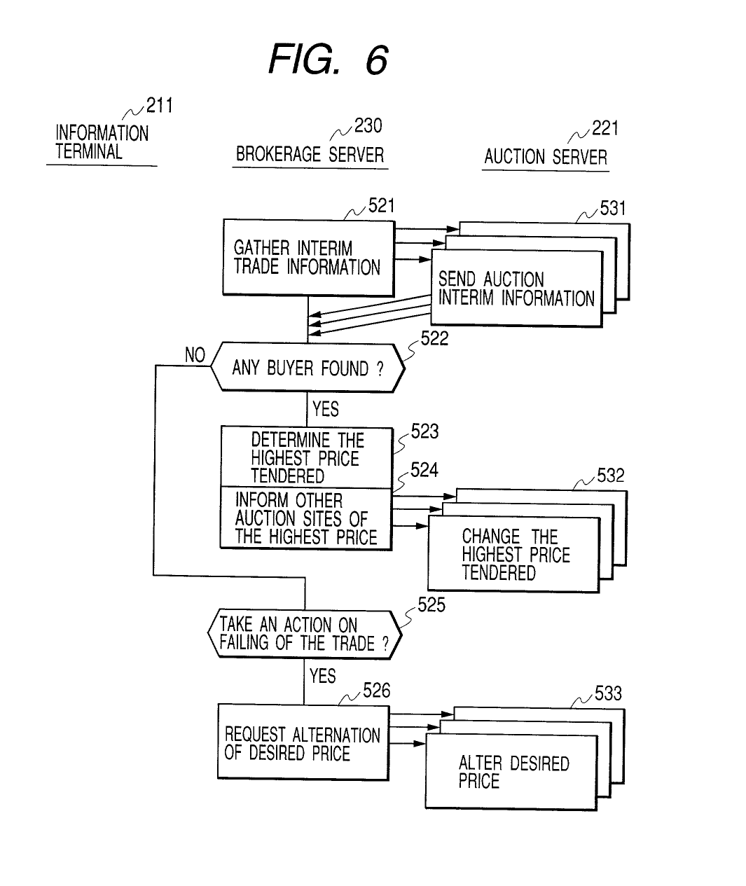

FIG. 6 is a flow chart showing a process flow of the auction site monitoring section 242 to execute the process (3). The auction site monitoring section 242 accesses to the user information file 250 via the user request processing section 241 on a regular basis in order to acquire information about the auctioned commodity, the name of the sites at which the commodity is registered and each registration number, extracts cases in which an identical commodity is at a plurality of auction sites, and collects web pages of the auction sites at which such commodity is registered based on each registration number (step 521). Each auction server 221 sends web pages in which the commodity of the specified registration number is registered to the brokerage server 230 (step 531). Then, the auction site monitoring section 242 determines whether any buyer has been found at any auction site (step 522). If found, it compares tendered prices of all the auction sites at which the buyers have been found for such commodity to determine the highest tendered price (step 523). Then, it notifies other auction sites where the highest tendered price has not been found of the highest tendered price (step 524). Specifically, the auction site monitoring section 242 may place tenders with the highest tendered price to the other auction sites in the name of a substitute. For example, the identifier of the brokerage server 230 is used as the name of the substitute. Or it may alter the lower limit of the desired price of such commodity into the highest tendered price in the name of the user. This action unifies the highest tendered price of all the auction sites at which the identical commodity is registered to avoid a problem in which the identical commodity might be knocked down at plural different prices.

If no buyer has been found at every auction site (step 522 NO), the auction site monitoring section 242 determines whether to take action on failing of the trade (step 525). Specifically, it determines whether “alteration of the desired price when the trade is anticipated to fail” condition is set in use history of the corresponding user and whether the time has arrived to take such action. If these conditions are satisfied (step 525 YES), the auction site monitoring section 242 requests each auction site to alter the desired price in the name of the user (step 526). The auction servers 221 alter the desired price of the commodity having specified registration number to the above specified price (step 533). Here, instead of automatic alteration to the desired price based upon the “alteration of the desired price when the trade is anticipated to fail” entry which has been specified by the user, the auction site information processing section 243 may alter the desired price according to the user's request after executing the process (2) also in response to the user's request.

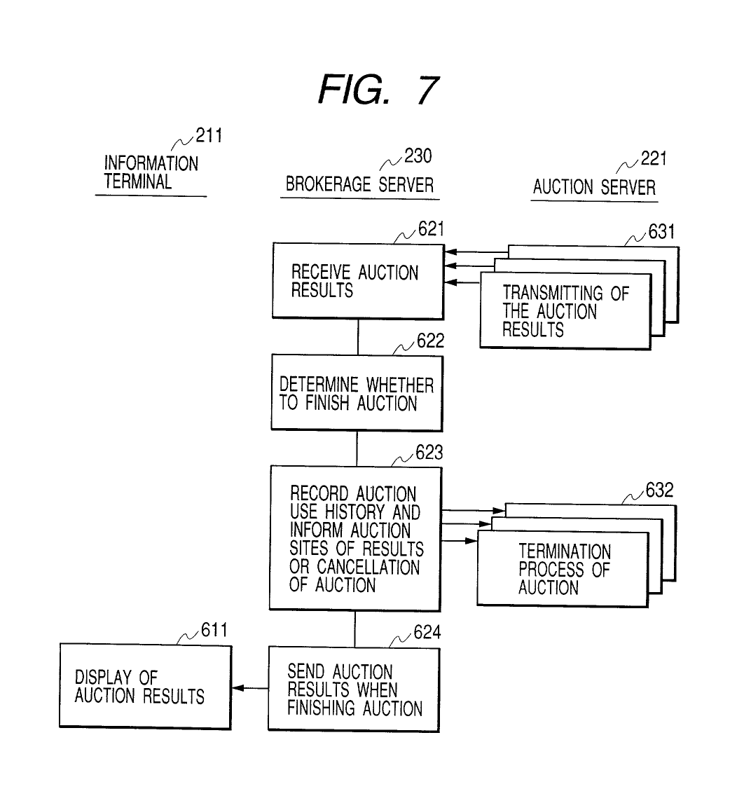

FIG. 7 is a flow chart showing a process flow of the user request processing section 241 and the auction site information processing section 243 to execute the process (4). When an auction period for each auctioned commodity has been terminated, each auction site notifies the brokerage server 230 of the auction results (step 631). Information sent from the auction servers 221 to the brokerage server 230 includes the registration number, the user name, success/fail of the trade, the trading price when the trade has succeeded, the name of the successful bidder and so on. The auction information processing section 243 receives such information and notifies the user request processing section 241 of it (step 621). Receiving the notification, the user request processing section 241 retrieves pieces of the personal user information 251 by using the name of the user and the registration number as a key and refers to the relevant piece of the personal user information 251 to determine whether to terminate the auction or not (step 622). If the trade has concluded with anyone other than the substitute, the auction is terminated. Or, regardless of whether the trade has succeeded, when the last auction result report for the user has been received, the auction is terminated. If the trade has concluded with the substitute and the commodity concerned is still registered at other auction sites, the auction will be continued. If the trade has failed and such commodity is still registered at other auction sites, the auction will be continued.

Then, the brokerage server 230 records auction results for each auction site that informed of its result in the relevant pieces of personal user information and notifies the auction sites of success/fail and/or cancellation (step 623). Specifically, at first, the brokerage server 230 sends a report of success/fail of the trade back to the auction sites that have issued notification according to such notification. In case of termination of the auction, if there remain other auction sites, the brokerage server 230 reports about cancellation for the commodity concerned and termination of the auction to the other auction sites. Upon receipt of such report, each auction site performs termination process (step 632). Specifically, each auction site 221 deletes the specified commodity from its web page and notifies the successful bidder of success of the trade and the trading price. If the auction is terminated according to the above determination, the user request processing section 241 sends the auction result to the information terminal 211 (step 624). The sent auction result includes the acceptance number, success/fail of the trade, and in case of success, the name of the site, the trading price and the name of the successful bidder. The information terminal 211 displays such auction result on its display device (step 611).

In case of success of the trade, if the user specifies that the payment shall be transferred to the registered account, the user request processing section 241 acquires the transfer account number from the personal user information 251 for the relevant user and sends the account number to the successful bidder to assist the payment procedure (the process (5)).

The auction service is beneficial to auction sites, too, because, through registration in the auction brokerage service the auction sites can put more commodities for auction than ever. Therefore, each auction site 221 accesses the brokerage server 230 independently to request for registration. The auction site information processing section 243 registers information about the requesting auction sites as the auction site information 261 in the auction site information file 260 (the process (6)).

In this embodiment, it is stated that the brokerage server 230 resides on the Internet and operates between the information terminals 211 and the auction servers 221, but the brokerage server 230 may be implemented on the information terminal 211 entirely or in part.

As described above, according to the invention, operation of such auction brokerage service allows the user to register the auctioned commodity at a plurality of the auction sites, whereby the user can get more bidders and expect higher bidding price.

What is claimed is:

1. A method for auction brokerage service provided by a computer that resides between an information terminal of a user and auction servers to perform brokerage operation for an auction, the method comprising steps of:
communicating with said information terminal to locate said auction servers suitable for the user's requirement;
communicating with the auction servers that have been selected by the user from said located auction servers to receive notification confirming that an auctioned commodity of the user has been registered at the auction servers;
communicating with said auction servers to receive auction result information; and
communicating with said information terminal to notify of the auction result information.

2. The method for auction brokerage service as claimed in claim 1, further comprising a step of monitoring trading status at said plurality of auction servers and communicating with relevant auction servers to notify the other auction sites of the highest tendered price among all tendered prices.

3. The method for auction brokerage service as claimed in claim 1, further comprising a step of communicating with the relevant auction servers to alter the desired price according to the user's instruction when the commodity has found no buyer at all of said auction sites where the commodity had been registered by the date specified by the user.

4. The method for auction brokerage service as claimed in claim 1, further comprising a step of communicating with relevant auction servers to notify other auction sites of cancellation of registration of the corresponding commodity, in case of termination of the auction when the commodity has found the buyer at any of said auction sites.

5. In a computer system, a method executed by a machine residing between an auction user and auction organizers to perform brokerage operation for an auction, said computer system having a computing environment at the side of the auction user, a plurality of computing environments at the side of the auction organizers, and a computing environment at the broker side, the method comprising steps of:
(a) receiving information about an auctioned commodity and at least one specified auction organizer from the computing environment at the side of the auction user;
(b) sending the information about the auctioned commodity to the specified auction organizers;
(c) monitoring trading status of said auctioned commodity by communicating with the computing environment at the side of the specified auction organizers;
(d) notifying the computing environment at other auction organizers of the highest bidding price among all bidding prices to unify bidding prices at the side of said auction organizers into the highest price if any buyer has been found for said auctioned commodity at any of said auction organizers; and
(e) taking an action in accordance with conditions specified by the auction user if no buyer has been found for said auctioned commodity at all of said auction organizers.

6. The method for auction brokerage service as claimed in claim 5, further comprising a step of notifying the computing environment at the side of said auction organizers of alternation of the desired price according to the instruction of the auction user if no buyer has been found for said auctioned commodity at all of said auction organizers by the date specified by the auction user.

7. The method for auction brokerage service as claimed in claim 5, further comprising a step of notifying the computing environment at the side of the other auction organizers where said auctioned commodity is registered of cancellation of registration when any buyer has been found at any of said auction organizers and the auction is terminated.

8. A computer for residing between an information terminal of a user and auction servers to perform brokerage service for an auction, said computer comprising:
(a) means for receiving information about an auctioned commodity and at least one specified auction server from said information terminal;
(b) means for sending the information about the auctioned commodity to the specified auction servers;
(c) means for monitoring trading status of said auctioned commodity by communicating with the specified auction servers;
(d) means for notifying the other auction servers of the highest bidding price among all bidding prices to unify bidding prices at said auction servers into the highest price if any buyer has been found for said auctioned commodity at any of said auction servers; and
(e) means for taking an action in accordance with conditions specified by said information terminal if no buyer has been found for said auctioned commodity at all of said auction sites.

9. The computer as claimed in claim 8, wherein said means for taking the action further comprises means for notifying said auction servers of alternation of the desired price according to the instruction of the user if no buyer has been found for said auctioned commodity at all of said auction servers by the date specified by the user.

10. The computer as claimed in claim 8, further comprising means for notifying the other auction servers where said auctioned commodity is registered of cancellation of registration when any buyer has been found at any of said auction servers and the auction is terminated.
